(19) United States
(12) Patent Application Publication
(10) Pub. No.: US 2019/0318485 A1
(43) Pub. Date: Oct. 17, 2019

(54) IMAGE ANALYSIS APPARATUS, METHOD, AND PROGRAM

(71) Applicant: OMRON Corporation, Kyoto-shi (JP)

(72) Inventors: Daiki SHICHIJO, TOKYO (JP); Tomoyoshi AIZAWA, Kyoto-shi (JP); Hatsumi AOI, Kyoto-shi (JP)

(73) Assignee: OMRON Corporation, Kyoto-shi (JP)

(21) Appl. No.: 16/352,927

(22) Filed: Mar. 14, 2019

(30) Foreign Application Priority Data
Apr. 13, 2018 (JP) 2018-077877

(51) Int. Cl. G06T 7/238; G06K 9/00

(52) U.S. Cl. CPC G06T 7/238; G06K 9/00228; G06K 9/0055

(57) ABSTRACT

During tracking, a rough search is performed on a face image area detected in a current frame, and when the reliability of the result of the rough search is equal to or smaller than a threshold value, a value obtained by multiplying a reliability of a rough search result detected in one previous frame by a predetermined coefficient is set as a new threshold value, and it is determined whether or not the reliability of the rough search result detected in the current frame exceeds the newly set threshold value. Then, when the reliability of the rough search result exceeds the new threshold value, the decrease in reliability of the rough search result is considered as temporary, and a tracking flag is kept on while tracking information is also held.

### CROSS-REFERENCE TO RELATED APPLICATION

This application is based on Japanese Patent Application No. 2018-077877 filed with the Japan Patent Office on Apr. 13, 2018, the entire contents of which are incorporated herein by reference.

### FIELD

Embodiments relate to an image analysis apparatus, method, and program used for detecting an object to be detected such as a human face from a captured image, for example.

### BACKGROUND

For example, in a monitoring field such as driver monitoring, there have been proposed techniques in which an image area including a human face is detected from an image captured by a camera, and positions of a plurality of organs such as eyes, a nose, and a mouth, an orientation of the face, and the like are estimated from the detected face image area.

Among the techniques, as a method for detecting the image area including the human face from the captured image, a known image processing technique such as template matching is known. This technique is, for example, detecting from the captured image an image area in which the degree of matching with an image of a template exceeds a threshold value, while moving the position of a previously prepared face reference template stepwise with respect to the captured image at a predetermined number of pixel intervals, and extracting the detected image area with, for example, a rectangular frame to detect a human face.

Meanwhile, in this face detection technique, when the threshold value is set to a strict condition, the face to be detected can be detected with high accuracy, but depending on the quality of the captured image or the like, detection leakage of a face image to be originally detected may occur. In contrast, when the threshold value is set to a relaxed condition, it is possible to reduce the detection leakage, whereas it frequently happens that an image not to be detected is erroneously detected as a face image.

There has thus been proposed a technique in which, at the time of determining whether or not a face image detected by face detection processing is a face to be detected, when the reliability of the face detection result is continuously detected for a preset number of frames or time (e.g., see Japanese Patent No. 5147670), an area detected at this time is determined as an area of the face image to be detected.

However, according to the technique disclosed in Japanese Patent No. 5147670, when the same face image as the face image detected in the previous frame cannot be detected in the current frame, the face image area detected in the previous frame is deleted and the search for the face image area to be detected is restarted from the beginning. Thus, for example, even when a face of a subject is temporarily hidden by a hand, hair, or the like, or when a part of the face is out of the face image area by movement of the subject, the face image area detected in the previous frame is deleted, and the detection of the face image area is restarted from the beginning. For this reason, the detection processing for the face image area has been frequently performed, causing an increase in the processing load amount of the apparatus.

### SUMMARY

One or more aspects have been made in view of the above circumstances and is to provide a technique capable of continuing a state of detection of an object to be detected even when the object to be detected in a detected state is temporarily not detected.

For solving the above problem, according to a first aspect, an image analysis apparatus includes: a search unit configured to perform processing of detecting an image area including an object to be detected in units of frames from a temporally input image; a reliability detector configured to detect a reliability indicating likelihood of an image area including the object to be detected, detected by the search unit for each of the frames; and a search controller configured to control an operation of the search unit based on the reliability detected by the reliability detector. The search controller determines whether a first reliability detected by the reliability detector in a first frame satisfies a preset first determination condition, and when the first reliability is determined to satisfy the first determination condition, the search controller holds position information of an image area detected by the search unit in the first frame and controls the search unit such that the detection processing is performed taking the held position information of the image area as an area to be detected in a subsequent second frame. When the second reliability detected by the reliability detector in the second frame is determined not to satisfy the first determination condition, the search controller determines whether a second reliability satisfies a second determination condition that is more relaxed than the first determination condition, and when the second reliability is determined to satisfy the second determination condition, the search controller continues holding of the position information of the image area detected in the first frame and controls the search unit such that the detection processing is performed taking the position information of the image area as an area to be detected in a subsequent third frame. In contrast, when the second reliability is determined not to satisfy the second determination condition, the search controller cancels holding of the position information of the image area and controls the search unit such that processing of detecting an image area including the object to be detected is newly performed.

According to a first aspect, for example, in a state where the position information of the image area including the object to be detected is stored, even when the reliability of the search result of the object to be detected in a certain frame temporarily stops satisfying the first determination condition due, for example, to a change, movement, or the like of the object to be detected, the storage of the position information of the image area is kept so long as the reliability satisfies the second condition that is more relaxed than the first determination condition. This, for example, eliminates the need to restart detection of the image area in which the object to be detected exists from the beginning every time a temporary decrease in reliability occurs due to a change, movement, or the like of the object to be detected, thereby making it possible to stably and efficiently perform processing of detecting the image area including the object to be detected.

According to a second aspect, in a first aspect, the search unit performs rough search processing of detecting an image area in which the object to be detected exists with first search accuracy and detailed search processing of detecting an image area in which the object to be detected exists with second search accuracy higher than the first search accuracy by taking, as an image area to be detected, the image area detected by the rough search processing and an area including a predetermined range around the image area based on position information of the image area, and the reliability detector detects a rough search reliability indicating likelihood of the image area including the object to be detected, detected by the rough search processing, and a detailed search reliability indicating likelihood of the image area including the object to be detected, detected by the detailed search processing. Then, the first determination unit determines whether the detailed search reliability satisfies a determination condition for detailed search, and the first controller holds the position information of the image area detected by the search unit in the first frame when the detailed search reliability is determined to satisfy the determination condition for detailed search.

According to a second aspect, the rough search and the detailed search are performed, for example, at the time of detecting the image area in which the object to be detected exists, and the reliability of the search result is detected for each of these searches. Then, at the time of specifying the image area in which the object to be detected exists, that the reliability of the detailed search satisfies the determination condition is a condition. Therefore, it is possible to accurately specify the area in which the object to be detected exists.

According to a third aspect, in a second aspect, when the rough search reliability detected in the rough search processing for the second frame is determined not to satisfy a first determination condition for rough search, the second determination unit determines whether the rough search reliability detected in the rough search processing for the second frame satisfies a second determination condition that is more relaxed than the first determination condition. When the rough search reliability detected in the rough search processing for the second frame is determined to satisfy the second determination condition, the second controller continues holding of the position information of the image area. In contrast, when the rough search reliability detected in the rough search processing for the second frame is determined not to satisfy the second determination condition, the third controller cancels holding of the position information of the image area.

According to a third aspect, it is determined whether the decrease in reliability is temporary based on the reliability detected in the rough search. Here, when the state in which the reliability detected in the rough search does not satisfy the determination condition continues for a certain number of frames or longer, there is a possibility that the reliability detected in the detailed search may not be held. However, as described above, it is possible to reliably perform the above determination by determining whether the decrease in reliability is temporary based on the reliability detected in the rough search.

According to a fourth aspect, in a second aspect, when the detailed search reliability detected in the detailed search processing for the second frame is determined not to satisfy a third determination condition for detailed search, the second determination unit determines whether the rough search reliability detected in the rough search processing for the second frame satisfies a second determination condition that is more relaxed than the first determination condition for rough search. When the rough search reliability detected in the rough search processing for the second frame is determined to satisfy the second determination condition, the second controller continues holding of the position information of the image area. In contrast, when the rough search reliability detected in the rough search processing for the second frame is determined not to satisfy the second determination condition, the third controller cancels holding of the position information of the image area.

According to a fourth aspect, also when the detailed search reliability detected in the detailed search processing for the second frame is determined not to satisfy the third determination condition, it is determined whether the decrease in reliability is temporary based on the reliability detected in the rough search. Therefore, for example, even when the rough search reliability in the second frame is favorable and the detailed search reliability decreases, it is determined whether or not the rough search reliability satisfies the second determination condition that is more relaxed than the first determination condition, and based on the determination result, it is possible to control whether or not to hold the position information of the image area detected in the first frame.

According to a fourth aspect, in a second or a third aspect, the second determination unit uses a reliability obtained by decreasing the rough search reliability detected by the reliability detector in the first frame by a predetermined value as the second determination condition.

According to a fourth aspect, the second determination condition for determining whether the decrease in reliability is temporary is set based on the first reliability of the rough search result in the previous frame, for example. For this reason, whether the decrease in reliability is temporary is always determined based on the reliability in the previous frame. Therefore, as compared with a case where a fixed value is used as the second determination condition, it is possible to make a more appropriate determination in consideration of a temporary change form of the object to be detected.

That is, according to one or more aspects, it is possible to provide a technique capable of holding a state of detection of an object to be detected even when the object to be detected is temporarily not detected.

### BRIEF DESCRIPTION OF THE DRAWINGS

FIG. 1 is a block diagram illustrating one application example of an image analysis apparatus according to one or more embodiments;

FIG. 2 is a block diagram illustrating an example of a hardware configuration of an image analysis apparatus according to one or more embodiments;

FIG. 3 is a block diagram illustrating an example of a software configuration of an image analysis apparatus according to one or more embodiments;

FIG. 4 is a flow diagram illustrating an example of an entire processing procedure and processing contents of image analysis processing by an image analysis apparatus, such as in FIG. 3;

FIG. 5 is a flow diagram illustrating one of subroutines of an image analysis processing, such as in FIG. 4;

FIG. 6 is a flow diagram illustrating one of subroutines of an image analysis processing, such as in FIG. 4;

FIG. 7 is a diagram illustrating an example of rough search processing in an image analysis processing, such as in FIG. 4;

FIG. 8 is a diagram illustrating an example of detailed search processing in an image analysis processing, such as in FIG. 4;

FIG. 9 is a diagram illustrating an example of a face image area detected by rough search processing, such as in FIG. 7;

FIG. 10 is a diagram illustrating an example of a search operation in a case of using a method of searching feature points of a face as a method of rough search processing and detailed search processing;

FIG. 11 is a diagram illustrating an example in which a part of a face image area is hidden by a hand;

FIG. 12 is a diagram illustrating another example of feature points of a face; and

FIG. 13 is a diagram illustrating an example in which feature points of a face are three-dimensionally displayed.

### DETAILED DESCRIPTION

Embodiments will be described below with reference to the drawings.

### Application Example

First, an application example of the image analysis apparatus according to one or more embodiments will be described.

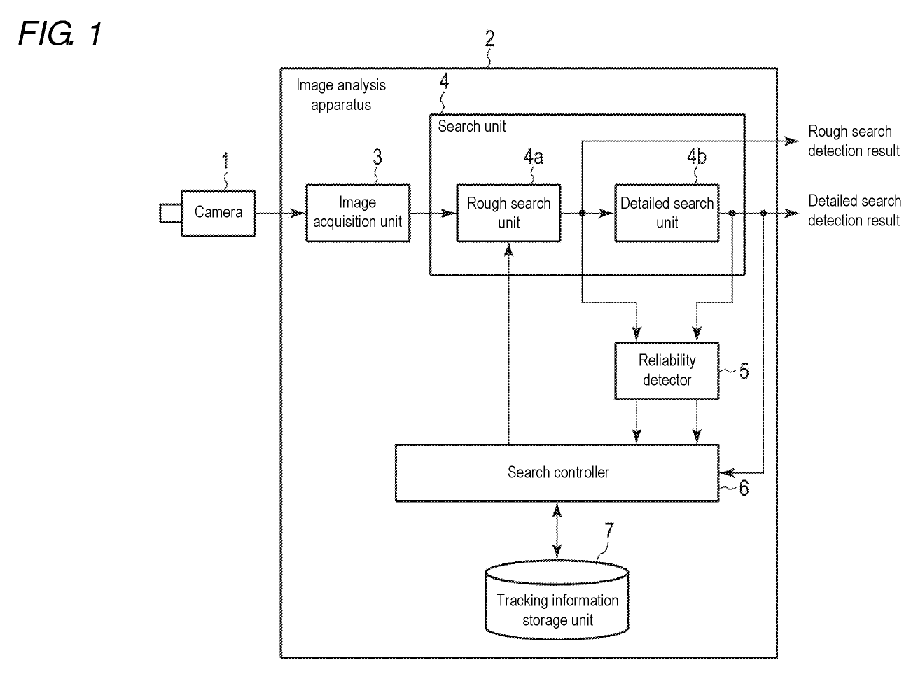

The image analysis apparatus according to one or more embodiments is used, for example, in a driver monitoring apparatus that monitors the state of the driver's face (e.g., face expression, face orientation, sight line direction) and configured, for example, as illustrated in FIG. 1.

An image analysis apparatus 2 is connected to a camera 1. For example, the camera 1 is installed at a position facing the driver's seat, captures an image of a predetermined range including the face of the driver seated in the driver's seat in a constant frame period, and outputs the image signal.

The image analysis apparatus 2 includes an image acquisition unit 3, a search unit 4 functioning as a face detector, a reliability detector 5, a search controller 6, and a tracking information storage unit 7.

For example, the image acquisition unit 3 sequentially receives image signals output from the camera 1, converts the received image signals into image data made up of digital signals for each frame, and stores the image data into the image memory.

The search unit 4 reads the image data acquired by the image acquisition unit 3 from the image memory for each frame, and detects an image area including the driver's face from the image data. For example, the search unit 4 employs the template matching method. While moving the position of the face reference template stepwise with respect to the image data at a predetermined number of pixel intervals, the search unit 4 detects from the image data an image area in which the degree of matching with the image of the reference template exceeds the threshold value, and extracts the detected image area. For example, a rectangular frame is used to extract the face image area.

The search unit 4 includes a rough search unit 4a and a detailed search unit 4b. Of these search units, for example, the rough search unit 4a moves the position of the face reference template with respect to the image data stepwise at intervals of a plurality of preset plural pixels (e.g., 8 pixels). A correlation value between the image data and the face reference template is detected for each step-movement position, the correlation value is compared with a first threshold value, and an image area corresponding to the position of the face reference template at the time when the correlation value exceeds the first threshold value is detected with, for example, the rectangular frame. That is, the rough search unit 4a detects an area in which a face image exists at rough search intervals and enables a high-speed search for a face image.

On the other hand, for example, based on the image area (rough detection area) detected by the rough search unit 4a, the detailed search unit 4b takes the rough detection area and a predetermined range in the vicinity of the rough detection area (e.g., a range enlarged by two pixels in each of the upward, downward, leftward and rightward directions) as a search range, and moves the face reference template with respect to the search range stepwise at pixel intervals (e.g., one-pixel intervals) set more densely than the rough search intervals used in the rough search. Then, a correlation value between the image data and the face reference template is detected for each step-movement position, the correlation value is compared with a second threshold value set to a value higher than the first threshold value, and an image area corresponding to the position of the face reference template at the time when the correlation value exceeds the second threshold value is detected with, for example, the rectangular frame. That is, the detailed search unit 4b detects an area in which a face image exists at dense search intervals, and enables a detailed search for a face image.

The search method in the rough search unit 4a and the detailed search unit 4b is not limited to the template matching method, but there may be used a search method using a three-dimensional face shape model in which a plurality of feature points set corresponding to positions of a plurality of organs (e.g., eyes, nose, mouth) of a general face have been created in advance by learning or the like. In the search method using the three-dimensional face shape model, for example, by projecting a three-dimensional face shape model onto image data, the feature amount of each of the organs is obtained from the image data. Then, the three-dimensional position of each feature point in the image data is estimated based on an error amount with respect to a correct value of the acquired feature amount and the three-dimensional face shape model at the time when the error amount is within the threshold value.

For each of the detection result of the face image area (rough detection area) by the rough search unit 4a and the detection result of the face image area (detailed detection area) by the detailed search unit 4b, the reliability detector 5 calculates the reliability indicating the likelihood. As a reliability detection method, for example, there is used a method in which a feature of a face image stored in advance and the feature of the image of the face image area detected by each of the search units 4a and 4b are compared to obtain a probability that an image of the detected face image area is the image of the subject, and the reliability is calculated from this probability. As another detection method, it is possible to use a method of calculating a difference between the feature of the face image stored in advance and the feature of the image of the face image area detected by each of the search units 4a and 4b, and calculates the reliability from the magnitude of the difference.

The search controller 6 controls the detection operation for the face image area by the search unit 4 based on the reliability of the rough search and the reliability of the detailed search detected by the reliability detector 5.

For example, when the reliability of the detailed search exceeds the threshold value in a frame in which the face image area is detected, the search controller 6 sets a tracking flag on and stores position information of the face image area detected at this time into the tracking information storage unit 7. Then the rough search unit 4a is instructed to use the stored position information of the face image area as a reference position for detecting the face image area in a subsequent frame of the image data.

When the reliability of the rough search detected in the current frame is equal to or smaller than the threshold value in a state where the tracking flag is set on, the search controller 6 sets as a new threshold a value obtained by decreasing the reliability of the rough search detected in the previous frame by a predetermined value and determines whether or not the reliability of the rough search detected in the current frame exceeds the new threshold value.

As a result of the determination, when the reliability of the rough search detected in the current frame exceeds the new threshold value, the search controller 6 keeps the tracking flag on and also keeps holding of the position information of the face image area stored in the tracking information storage unit 7. Then, the rough search unit 4a is instructed to use the stored position information of the face image area as a reference position for detecting the face image area also in the subsequent frame.

In contrast, when the reliability of the rough search detected in the current frame is determined to be equal to or smaller than the new threshold value, the search controller 6 resets the tracking flag to be off and deletes the position information of the face image area stored in the tracking information storage unit 7. Then, the rough search unit 112 is instructed to restart the detection processing for the face image area from the initial state in the subsequent frame.

With the above configuration, at the time of detecting the area including the face image in a certain frame, when the reliability of the detailed search exceeds the threshold value, it is determined that the face image with high reliability has been detected and the tracking flag is turned on, and the position information of the face image area detected in the frame is stored into the tracking information storage unit 7. Then, in the next frame, the face image area is detected taking the position information of the face image area stored in the tracking information storage unit 7 as the reference position. Thus, as compared with a case where the face image area is always detected from the initial state in each frame, the face image area can be detected efficiently.

On the other hand, in a state where the tracking flag is on, it is determined whether the reliability of the rough search exceeds the threshold value for each frame. Then, when the reliability of the rough search decreases to or below the threshold value, a value obtained by decreasing the reliability of the rough search in the previous frame by a predetermined value is generated as a new threshold value, and it is determined whether or not the reliability of the rough search in the current frame exceeds the threshold value.

As a result of this determination, when the reliability of the rough search in the current frame exceeds the new threshold value, the decrease in reliability of the face image detected in the current frame is considered as being within an allowable range, and in the subsequent frame, the detection processing for the face image is performed taking the position information of the face image area stored in the tracking information storage unit 7 as the reference position. Accordingly, for example, when the driver's face is temporarily hidden by the hand, hair or the like, or when a part of the face is temporarily out of the reference position of the face image area due to the body movement of the driver, the tracking state is not canceled but can be continued, so that the detection efficiency and the stability of the face image can be held high.

In contrast, when the reliability of the rough search in the current frame does not exceed the new threshold value, the decrease in reliability of the face image detected in the current frame is considered as exceeding the allowable range. Then, the tracking flag is reset to be off and the position information of the face image area stored in the tracking information storage unit 7 is also deleted. As a result, the search unit 4 performs the face image area detection processing from the initial state. Therefore, for example, when it becomes impossible to detect the face due to the driver changing the posture or moving to a seat during automatic driving, the detection processing for the face image is performed immediately from the initial state in the next frame. It is thereby possible to promptly restart detection of the driver's face.

### One Embodiment

### Configuration Example

(1) System

An image analysis apparatus according to one or more embodiments is used, for example, in a driver monitoring system for monitoring the state of a face of a driver. In this example, the driver monitoring system includes a camera 1 and an image analysis apparatus 2.

The camera 1 is disposed, for example, at a position of the dashboard facing the driver. The camera 1 uses, for example, a complementary metal-oxide-semiconductor (CMOS) image sensor capable of receiving near infrared light as an imaging device. The camera 1 captures an image of a predetermined range including the driver's face and transmits its image signal to the image analysis apparatus 2 via, for example, a signal cable. As the imaging device, another solid-state imaging device such as a charge coupled device (CCD) may be used. Further, the installation position of the camera 1 may be set anywhere as long as being a place facing the driver, such as a windshield or a room mirror.

(2) Image Analysis Apparatus

The image analysis apparatus 2 detects the face image area of the driver from the image signal obtained by the camera 1 and estimates the state of the driver's face such as the expression of the face, the orientation of the face, and the sight line direction, based on the face image area. In this example, only the function of detecting a face image area, which is a main constituent element of one or more embodiments, will be described and the description of the face state estimating function will be omitted.

(2-1) Hardware Configuration

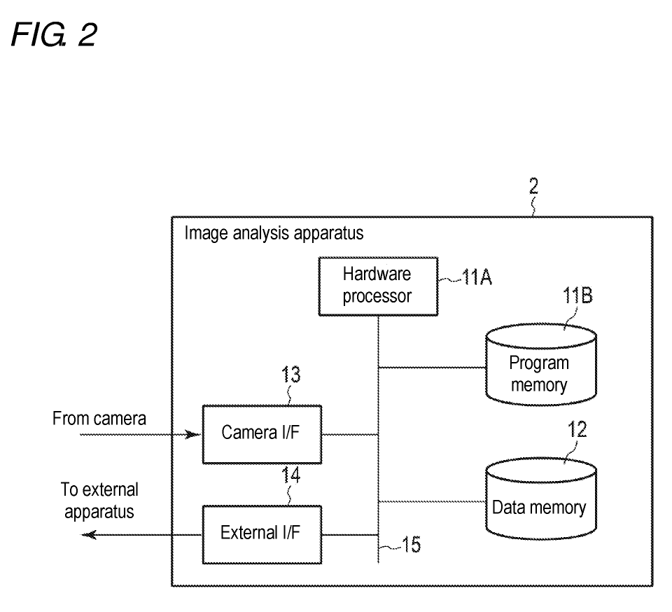

FIG. 2 is a block diagram illustrating an example of a hardware configuration of the image analysis apparatus 2.

The image analysis apparatus 2 has a hardware processor 11A such as a central processing unit (CPU). Then, a program memory 11B, a data memory 12, a camera interface (camera I/F) 13, and an external interface (external I/F) 14 are connected to the hardware processor 11A via a bus 15.

The camera I/F 13 receives an image signal output from the camera 1 via a signal cable. The external I/F 14 outputs information representing the detection result of the state of the face to an external apparatus, such as a driver state determination apparatus that determines inattentiveness or drowsiness, or an automatic driving control apparatus that controls the operation of the vehicle.

When an in-vehicle wired network such as a local area network (LAN) and an in-vehicle wireless network adopting a low power wireless data communication standard such as Bluetooth (registered trademark) are provided in the vehicle, signal transmission between the camera 1 and the camera I/F 13 and between the external I/F 14 and the external apparatus may be performed using the network.

The program memory 11B uses, for example, a nonvolatile memory such as a hard disk drive (HDD) or a solid state drive (SSD) that can be written and read as needed and a nonvolatile memory such as a read-only memory (ROM) as storage mediums, and stores programs necessary for executing various kinds of control processing according to one or more embodiments.

The data memory 12 includes, for example, as a storage medium, a combination of a nonvolatile memory such as an HDD or an SSD that can be written and read as needed and a volatile memory such as a read-access memory (RAM). The data memory 12 is used to store various pieces of data acquired, detected, and calculated in the course of executing various processing according to one or more embodiments, template data, and other data.

(2-2) Software Configuration

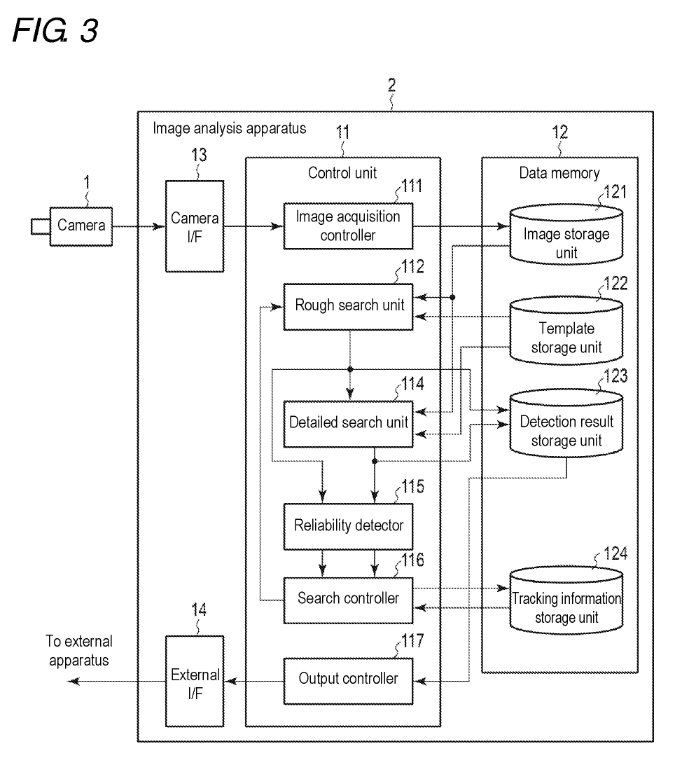

FIG. 3 is a block diagram illustrating a software configuration of the image analysis apparatus 2 according to one or more embodiments.

In the storage area of the data memory 12, an image storage unit 121, a template storage unit 122, a detection result storage unit 123, and a tracking information storage unit 124 are provided. The image storage unit 121 is used to temporarily store image data acquired from the camera 1. In the template storage unit 122, a face reference template is stored, the face reference temperate being configured to detect an image area showing the face from the image data. The detection result storage unit 123 is used to store detection results of face image areas obtained by the rough search unit and the detailed search unit, which will be described later, respectively.

A controller 11 is made up of the hardware processor 11A and the program memory 11B, and as processing function units by software, the controller 11 includes an image acquisition controller 111, a rough search unit 112, a detailed search unit 114, a reliability detector 115, a search controller 116, and an output controller 117. These processing function units are all realized by causing the hardware processor 11A to execute the program stored in the program memory 11B.

The image signal output from the camera 1 is received by the camera I/F 13 for each frame and is converted into image data made of a digital signal. The image acquisition controller 111 performs processing of taking thereinto the image data for each frame from the camera I/F 13 and storing the image data into the image storage unit 121 of the data memory 12.

The rough search unit 112 reads the image data from the image storage unit 121 for each frame and uses the face reference template stored in the template storage unit 122 to detect an image area showing the driver's face from the read image data by the rough search processing.

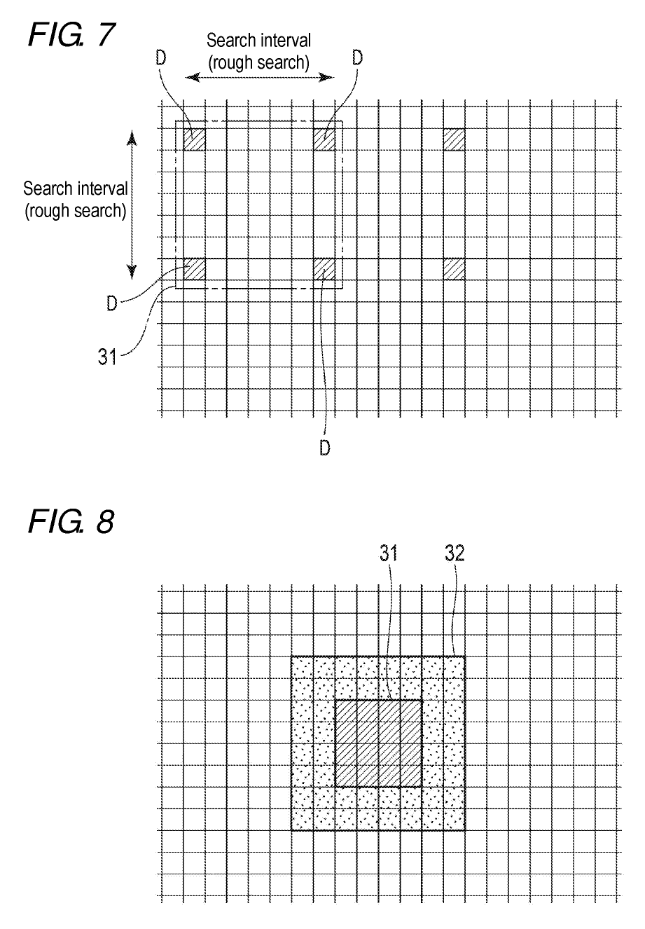

For example, the rough search unit 112 moves the face reference template stepwise at a plurality of preset pixel intervals (e.g., 8-pixel intervals as illustrated in FIG. 7) with respect to the image data, and calculates a luminance correlation value between the reference template and the image data for each position to which the reference template has moved. Then, the calculated correlation value is compared with a preset threshold value, and the image area corresponding to the step position with the calculated correlation value exceeding the threshold value is extracted as the face area showing the driver's face with the rectangular frame. The size of the rectangular frame is preset in accordance with the size of the driver's face shown in the captured image.

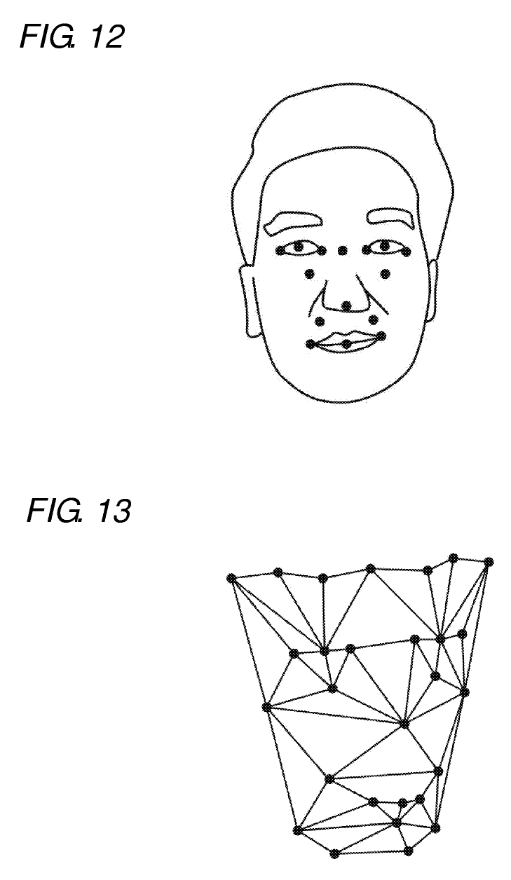

As the face reference template image, for example, a reference template corresponding to the contour of the entire face and a three-dimensional face shape model for searching a plurality of feature points set corresponding to the respective organs (eyes, nose, mouth, etc.) of the face can be used. FIG. 12 is a view exemplifying positions of feature point as objects to be detected of a face on a two-dimensional plane, and FIG. 13 is a diagram illustrating the above feature point as three-dimensional coordinates. In the examples of FIGS. 12 and 13, the case is illustrated where both ends (the inner corner and the outer corner of the eye) of and the center the eyes, the right and left cheek portions (orbital bottom portions), the vertex and the right and left end points of the nose, the right and left mouth corners, the center of the mouth, and the midpoints of the right and left points of the nose and the right and left mouth corners are set as feature points.

As a method of detecting a face by template matching, for example, there can be used of a method of detecting a vertex of a head or the like by chromakey processing and detecting a face based on the vertex, a method of detecting an area close to a skin color and detecting the area as a face, or other methods. Further, the rough search unit 112 may be configured to perform learning with a teacher signal through a neural network and detect an area that looks like a face as a face. In addition, the detection processing for the face image area by the rough search unit 112 may be realized by applying any existing technology.

For example, the detailed search unit 114 sets a range including the face image area and a predetermined range in the vicinity thereof as a detailed search range, based on position information of the face image area detected by the rough search unit 112. Then, the image data of the frame in which the rough search has been performed is read again from the image storage unit 121, and from the detailed search range of the image data, the image area showing the driver's face is detected using the face reference template by the detailed search processing.

For example, as illustrated in FIG. 8, the detailed search unit 114 sets a range obtained by enlarging a face image area 31 detected by the rough search processing by two pixels in each of the upward, downward, leftward and rightward directions as the detailed search range 32. Then, the face reference template is moved stepwise, pixel by pixel, with respect to the detailed search range 32, and a correlation value of luminance between the image in the detailed search range 32 and the face reference template is obtained for each movement. An image area corresponding to the step position at the time when the correlation value exceeds the threshold value and becomes the maximum is extracted with the rectangular frame.

The reliability detector 115 calculates a reliability α of the face image area detected by the rough search unit 112 and a reliability β of the face image area detected by the detailed search unit 114, respectively. As a reliability detection method, for example, there is used a method in which the feature of the face image of the subject, stored in advance, and the feature of the image of the face image area detected by each of the search units 112 and 114 are compared to obtain a probability that an image of the detected face area is the image of the subject, and the reliability is calculated from this probability.

The search controller 116 executes the following control based on the reliability α of the rough search and the reliability β of the detailed search detected by the reliability detector 115.

(1) In a certain frame of the face image data, when the reliability β of the detailed search exceeds the preset threshold value for detailed search, a tracking flag is set on, and position information of the face image area detected by the detailed search unit 114 at this time is stored into the tracking information storage unit 124. Then the rough search unit 112 is instructed to use the stored position information of the face image area as a reference position for detecting the face image area in a subsequent frame of the image data.

(2) When the reliability α(n) of the rough search result detected in the current frame is equal to or smaller than the threshold value while the tracking flag is set on, a value obtained by multiplying the reliability α(n−1) of the rough search result detected in the previous frame by a predetermined coefficient a (1>a>0) is set as a new threshold, and it is determined whether or not the reliability α(n) of the rough search result detected in the current frame exceeds the new threshold value. In addition, this determination processing is executed in the same way even when the reliability α(n) of the rough search result exceeds the threshold value and the reliability β(n) of the detailed search is equal to or smaller than the threshold value.

(3) In (2), when the reliability α(n) of the rough search result detected in the current frame is determined to exceed the new threshold value, the tracking flag is kept on, and the position information of the face image area stored in the tracking information storage unit 124 is held. Then, the rough search unit 112 is instructed to continue the position information of the stored face image area as the reference position for detecting the face image area also in the subsequent frame.

(4) In (2), when the reliability α(n) of the rough search result detected in the current frame is determined to be equal to or smaller than the new threshold value, the tracking flag is reset to be off, and the position information of the face image area stored in the tracking information storage unit 124 is deleted. Then, the rough search unit 112 is instructed to restart the detection processing for the face image area from the initial state in the subsequent frame.

(5) When the reliability α(n) of the rough search result and the reliability β(n) of the detailed search detected in the current frame both exceeds the threshold values while the tracking flag is set on, the position information of the face image area stored in the tracking information storage unit 124 is updated to the latest position information of the face image area detected by the detailed search unit 114 in the current frame.

The output controller 117 reads the image data of the face image area detected by the rough search and the detailed search from the detection result storage unit 123 and transmits the image data from the external I/F 14 to the external apparatus. As the external apparatus to which the image data is transmitted, for example, an inattention warning apparatus, an automatic driving control apparatus, and the like can be considered.

In the image analysis apparatus 2, it is also possible to estimate positions of feature points set in a plurality of organs of the face, the orientation of the face, and the sight line direction based on the image data of the face image area stored in the detection result storage unit 123, and transmit the estimation results from the output controller 117 to the external apparatus.

### Operation Example

Next, an operation example of the image analysis apparatus 2 configured as described above will be described.

In this example, it is assumed that the face reference template used for the processing of detecting the image area including the face from the captured image data is previously stored in the template storage unit 122. Two types of face reference templates are prepared, one for rough search and one for detailed search.

(2) Detection of Driver'S Face

The image analysis apparatus 2 executes processing for detecting the driver's face by using the face reference template stored in the template storage unit 122 as follows.

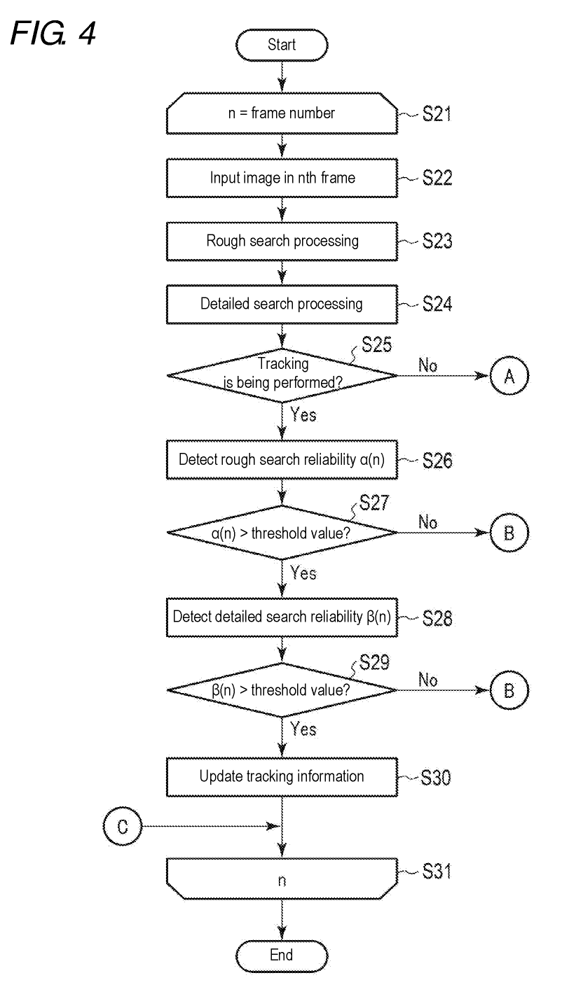

FIGS. 4 to 6 are flowcharts illustrating an example of a processing procedure and processing contents executed by the controller 11 at the time of detecting the face.

(2-1) Acquisition of Image Data

For example, an image of the driver in driving is taken from the front by the camera 1, and the image signal obtained by this is sent from the camera 1 to the image analysis apparatus 2. The image analysis apparatus 2 receives the image signal with the camera I/F 13, and converts the image signal into image data made of a digital signal for each frame.

Under control of the image acquisition controller 111, the image analysis apparatus 2 taking thereinto the image data for each frame and sequentially stores the image data into the image storage unit 121 of the data memory 12. The frame period of the image data stored into the image storage unit 121 can be set arbitrarily.

(2-2) Face Detection (During Non-Tracking)

(2-2-1) Rough Search Processing

Next, under control of the rough search unit 112, the image analysis apparatus 2 sets a frame number n to 1 in step S21, and then reads a first frame of the image data from the image storage unit 121 in step S22. In step S23, by using the face reference template for rough search stored in advance in the template storage unit 122, an image area showing the driver's face is detected from the read image data by the rough search processing, to detect an image of the face image area with the rectangular frame.

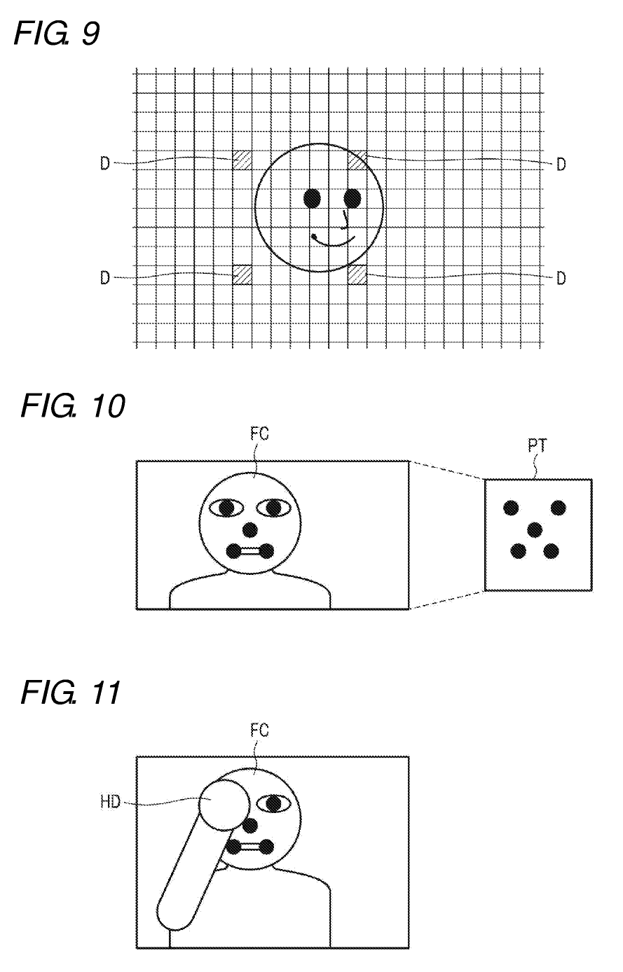

FIG. 7 is a diagram for explaining an example of the processing operation of the rough search processing by the rough search unit 112. As shown in the figure, the rough search unit 112 moves the face reference template for rough search stepwise at preset plurality of pixel intervals (e.g., 8 pixels) with respect to the image data. Each time the face reference template is moved by one step, the rough search unit 112 calculates a correlation value of luminance between the reference template and the image data, compares the calculated correlation value with a preset threshold value for rough search, and extracts an area corresponding to a step movement position with a correlation value exceeding the threshold value as the face image area including the face by using the rectangular frame. FIG. 9 illustrates an example of the face image area detected by the rough search processing.

(2-2-2) Detailed Search Processing

Next, under control of the detailed search unit 114, the image analysis apparatus 2 executes processing of detecting a more detailed face image area based on the face image area detected by the rough search in step S24.

For example, as illustrated in FIG. 8, the detailed search unit 114 sets a range obtained by enlarging the face image area 31 detected by the rough search processing by two pixels each in the upward, downward, leftward and rightward directions, as the detailed search range 32. Then, the face reference template is moved stepwise, pixel by pixel, with respect to the detailed search range 32, and a correlation value of luminance between the image in the detailed search range 32 and the face reference template for detailed search is obtained for each movement. An image area corresponding to the step position at the time when the correlation value exceeds the threshold value and becomes the maximum is extracted with the rectangular frame. Note that the face reference template used in the rough search processing may be used as it is in the detailed search processing as well.

(2-2-3) Shift to Tracking State

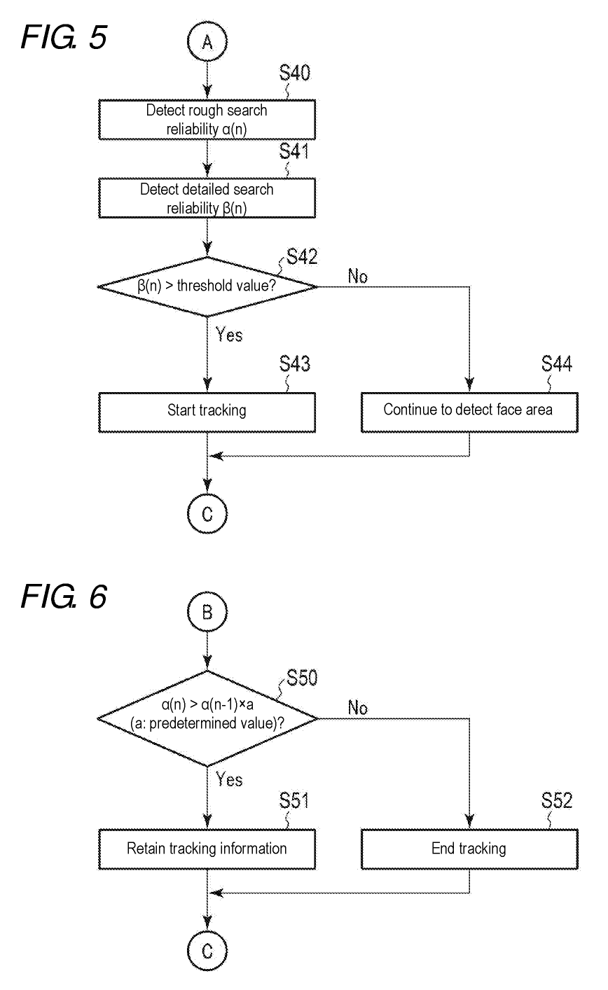

When the face image area is detected from the first frame of the image data by the rough search processing and the detailed search processing, subsequently, under control of the search controller 116, the image analysis apparatus 2 determines whether or not tracking is being performed in step S25. This determination is made based on whether or not the tracking flag is on. In the current first frame, since the tracking state is not yet established, the search controller 116 proceeds to step S40 illustrated in FIG. 5.

Under control of the reliability detector 115, in steps S40 and S41, the image analysis apparatus 2 calculates the reliability α(n) (here, n=1 due to the first frame) of the face image area detected by the rough search unit 112 and the reliability β(n) (n=1) of the face image area detected by the detailed search unit 114.

As a method for calculating these reliabilities α(n), β(n), for example, there is used a method in which the feature of the face image of the subject, stored in advance, and the feature of the image of the face image area detected by each of the search units 112 and 114 are compared to obtain a probability that an image of the detected face area is the image of the subject, and the reliability is calculated from this probability.

When the reliability α(n) of the rough search result and the reliability β(n) of the detailed search are calculated, under control of the search controller 116, the image analysis apparatus 2 compares the calculated reliability β(n) of the detailed search result with the threshold value in step S42. This threshold value is set to a value higher than the threshold value at the time of the rough search, for example, but may be the same value.

As a result of the comparison, when the reliability β(n) of the detailed search result exceeds the threshold value, the search controller 116 considers that the face image of the driver can be reliably detected, and proceeds to step S43, and turns on the tracking flag while storing the position information of the face image area detected by the detailed search unit 114 into the tracking information storage unit 124.

As a result of the comparison in step S42 above, when the reliability β(n) of the detailed search result is equal to or smaller than the threshold value, it is determined that the driver's face could not be detected in the first frame, and the face area detection processing is continued in step S44. That is, after incrementing the frame number n in step S31, the image analysis apparatus 2 returns to step S21 in FIG. 4 and executes a series of face detection processing in steps S21 to S31 above for a subsequent second frame.

(2-3) Face Detection (During Tracking)

(2-3-1) Rough Search Processing

When the tracking state is established, the image analysis apparatus 2 executes the face detection processing as follows. That is, under control of the rough search unit 112, in step S23, at the time of detecting the driver's face area from the next frame of the image data, the image analysis apparatus 2 takes the position of the face image area detected in the previous frame as the reference position and extracts an image included in the area with the rectangular frame in accordance with tracking information notified from the search controller 116.

(2-3-2) Detailed Search Processing

Subsequently, under control of the detailed search unit 114, in step S24, the image analysis apparatus 2 sets a range obtained by enlarging the face image area 31 detected by the rough search processing by two pixels in each of the upward, downward, leftward and rightward directions as the detailed search range 32. Then, the face reference template is moved stepwise, pixel by pixel, with respect to the detailed search range 32, and a correlation value of luminance between the image in the detailed search range 32 and the face reference template is obtained for each movement. An image area corresponding to the step position at the time when the correlation value exceeds the threshold value and becomes the maximum is extracted with the rectangular frame.

(2-3-3) Determination of Respective Reliabilities of Rough Search and Detailed Search

Upon completion of the rough search processing and detailed search processing, the image analysis apparatus 2 determines whether or not tracking is being performed in step S25 under control of the search controller 116. As a result of this determination, when tracking is being performed, the processing proceeds to step S26.

Under control of the reliability detector 115, in step S26, the image analysis apparatus 2 calculates the reliability α(n) of the rough search result (e.g., n=2 when the face detection is being performed for the second frame). Then, under control of the search controller 116, in step S27, the image analysis apparatus 2 compares the calculated reliability α(n) of the rough search result with the threshold value, and determines whether or not the reliability α(n) of the rough search result exceeds the threshold value. As a result of this determination, when the reliability α(n) of the rough search result exceeds the threshold value, the processing proceeds to step S28.

Further, under control of the reliability detector 115, in step S28, the image analysis apparatus 2 calculates the reliability β(n) of the detailed search result (e.g., n=2 when the face detection is being performed for the second frame). Then, under control of the search controller 116, in a step S29 the image analysis apparatus 2 compares the reliability β(n) of the calculated detailed search result with the threshold value, and determines whether or not the reliability β(n) of the detailed search result exceeds the threshold value. As a result of this determination, when the reliability β(n) of the detailed search result exceeds the threshold value, the processing proceeds to step S30.

(2-3-4) Tracking Update Processing

Subsequently, under control of the search controller 116, in step S30, the image analysis apparatus 2 stores position information of the latest face image area detected in the current frame into the tracking information storage unit 124 as tracking information. That is, the tracking information is updated. Then, after incrementing the frame number in step S31, the image analysis apparatus 2 returns to step S21 and repeats the processing in steps S21 to S31.

(2-3-5) Continuation of Tracking State

On the other hand, it is assumed that the reliability α(n) of the rough search result is determined to be equal to or smaller than the threshold value in the determination processing in step S27 above, or that the reliability β(n) of the detailed search result is determined to be equal to or smaller than the threshold value in the determination processing in step S29 above. In this case, under control of the search controller 116, the image analysis apparatus 2 proceeds to step S50 illustrated in FIG. 6. Then, a value obtained by multiplying the reliability α(n−1) of the rough search result detected in the previous frame n−1 by a predetermined coefficient a (a is: 1>a>0) is set as a new threshold, and it is determined whether or not the reliability α(n) of the rough search result detected in the current frame exceeds the above newly set threshold value.

Then, when the reliability α(n) of the rough search result exceeds the new threshold value, the decrease in the reliability α(n) of the rough search result is regarded as an allowable range, and in step S51, the tracking flag is kept on while tracking information (the position information of the face image area detected in the previous frame) stored in the tracking information storage unit 124 is also retained (kept). Therefore, in the processing of detecting the face area for the subsequent frame, the tracking information is used as the reference position.

FIGS. 10 and 11 illustrate an example of a case where this tracking state is continued. It is assumed that in the previous frame, a face image as illustrated in FIG. 10 is detected, and in a state where position information of this face image area is stored as tracking information, the face image detected in the current frame is as illustrated in FIG. 11 such that a part of a driver's face FC is temporarily hidden by a hand HD. In this case, the reliability α(n) of the face image area detected by the rough search in the current frame is lower than the reliability α(n−1) of the face image area detected by the rough search in the previous frame, but when α(n) is higher than the threshold value α(n−1)×a, the decrease in reliability at this time is regarded as an allowable range, and the tracking state is continued. For this reason, as exemplified in FIG. 11, the tracking state is kept even when a part of the driver's face FC is temporarily hidden by the hand HD or a part of the face FC is temporarily hidden by the hair, or furthermore, even when a part of the face is temporarily out of the face image area being tracked due to a change in the posture of the driver.

(2-3-6) Cancellation of Tracking State

In contrast, when the reliability α(n) of the rough search result is equal to or smaller than the newly set threshold value α(n−1)×a in step S50 above, the search controller 116 determines that it is difficult to continue the tracking state due to a great decrease in the reliability α(n) of the rough search result. In step S52, the search controller 116 resets the tracking flag to be off and deletes the tracking information stored in the tracking information storage unit 124. Thus, in the subsequent frame, the rough search unit 112 executes processing of detecting the face area from the initial state without using the tracking information.

(Effect)

As described in detail above, in one or more embodiments, during tracking, the reliability α(n) of the face image area detected by the rough search processing in the current frame and the reliability β(n) of the face image area detected by the detailed search processing are compared with respective threshold values. Then, when at least one of the reliability α(n) and β(n) is equal to or smaller than the threshold value, a value obtained by multiplying the reliability α(n−1) of the rough search result detected in the previous frame n−1 by a predetermined coefficient a (a is: 1>a>0) is set as a new threshold, and it is determined whether or not the reliability α(n) of the rough search result detected in the current frame exceeds the above newly set threshold value α(n−1)×a. As a result of this determination, when the reliability α(n) of the rough search result exceeds the new threshold value α(n−1)×a, the decrease in the reliability α(n) of the rough search result is regarded as temporary, and the tracking flag is kept on while the tracking information stored in the tracking information storage unit 124 is also held (kept).

Therefore, even when the reliability α(n) of the rough search result of the face area or the reliability β(n) of the detailed search result in a certain frame is temporarily equal to or smaller than the threshold value, the tracking state is kept so long as the amount of decrease in the reliability α(n) of the rough search result is within the allowable range. Therefore, for example, even when a part of the face is temporarily hidden by a hand or hair or a part of the face is temporarily out of the face image area being tracked due to a change in the posture of the driver, it is possible to keep the tracking state. As a result, it becomes unnecessary to restart detection of the image area of the face from the beginning each time a temporary decrease in reliability of the rough search result of the face occurs, so that the face detection processing can be performed more stably and efficiently.

When the state in which the reliability detected in the rough search does not satisfy the determination condition continues for a certain number of frames or longer, there is a possibility that the reliability detected in the detailed search may not be held. However, it is possible to reliably perform the above determination by determining whether or not the decrease in reliability is temporary based on the reliability detected in the rough search.

### Modified Examples

(1) In one or more embodiments, once the state shifts to the tracking state, the tracking state is kept thereafter unless the reliability of the detection result of the face area changes significantly. However, there is a concern that, when the apparatus erroneously detects a still pattern such as a face image of a poster or a pattern of a sheet, the tracking state may be permanently prevented from being cancelled. Therefore, for example, when the tracking state continues even after the lapse of a time corresponding to a certain number of frames from shifting to the tracking state, the tracking state is forcibly cancelled after the lapse of the above time. In this way, even when an erroneous object is tracked, it is possible to reliably get out of this erroneous tracking state.

(2) In one or more embodiments, the description has been given taking the case as the example where the driver's face is detected from the input image data. However, the object to be detected is not limited thereto and may be any object so long as enabling setting of the reference template or the shape model. For example, the object to be detected may be a whole-human body image, an organ image obtained by a tomographic imaging apparatus such as computed tomography (CT), or the like. In other words, the present technology can be applied to an object having individual differences in size and an object to be detected deformed without changing the basic shape. Further, even in a rigid object to be detected which does not deform like an industrial product such as a vehicle, an electric product, electronic equipment, or a circuit board, the present technology can be applied since a shape model can be set.

(3) In one or more embodiments, the description has been given taking the case as the example where the face is detected for each frame of the image data, but it is also possible to detect the face every plural preset frames. In addition, the configuration of the image analysis apparatus, the processing procedure and processing contents of each of the rough search and detailed search of the feature points of the object to be detected, the shape and size of the extraction frame, and the like can be variously modified without departing from the gist of the present invention.

Although embodiments have been described in detail above, the above description is merely an example of the present invention in all respects. It goes without saying that various improvements and modifications can be made without departing from the scope of the present invention. That is, in practicing the present invention, a specific configuration according to one or more embodiments may be adopted as appropriate.

In short, the present invention is not limited to the above embodiments, and structural elements can be modified and embodied in the implementation stage without departing from the gist thereof. In addition, various embodiments can be formed by appropriately combining a plurality of constituent elements disclosed in the above embodiments. For example, some constituent elements may be deleted from all the constituent elements shown in one or more embodiments. Further, constituent elements over different embodiments may be combined as appropriate.

[Appendix]

Part or all of each of the above embodiments may be described as shown in the appended description below in addition to the claims, but it is not limited thereto.

(Appendix 1)

An image analysis apparatus including a hardware processor (11A) and a memory (11B), the image analysis apparatus being configured such that the hardware processor (11A) performs the following by executing a program stored in the memory (11B):

performing processing of detecting an image area including an object to be detected in units of frames from a temporally input image;

detecting a reliability that indicates likelihood of an image area including the object to be detected, detected by a search unit for each of the frames; and controlling an operation of the search unit based on the reliability detected by a reliability detector,

the image analysis apparatus being configured to cause the hardware processor (11A) to further perform the following as processing of controlling the search operation:

determining whether a first reliability detected by the reliability detector in a first frame satisfies a preset first determination condition;

holding position information of an image area detected by the search unit in the first frame and controlling the search unit such that the detection processing is performed taking the held position information of the image area as an area to be detected in a subsequent second frame, when the first reliability is determined to satisfy the first determination condition;

determining whether a second reliability, detected by the reliability detector in the second frame, satisfies a second determination condition that is more relaxed than the first determination condition, when the second reliability is determined not to satisfy the first determination condition;

continuing holding of the position information of the image area detected in the first frame and controlling the search unit such that the detection processing is performed taking the position information of the image area as an area to be detected in a subsequent third frame, when the second reliability is determined to satisfy the second determination condition; and

cancelling holding of the position information of the image area and controlling the search unit such that processing of detecting an image area including the object to be detected is newly performed, when the second reliability is determined not to satisfy the second determination condition.

(Appendix 2)

An image analysis method executed by an apparatus including a hardware processor (11A) and a memory (11B) that stores a program to be executed by the hardware processor (11A), the image analysis method comprising:

a search step of performing, by the hardware processor (11A), processing of detecting an image area including an object to be detected in units of frames from a temporally input image;

a reliability detecting step of detecting, by the hardware processor (11A), a reliability that indicates likelihood of an image area including the object to be detected, detected in the search step for each of the frames; and

a search controlling step of controlling, by the hardware processor (11A), processing in the search step based on the reliability detected by the reliability detecting step,

wherein in the search controlling step,

the hardware processor (11A) determines whether a first reliability detected by the reliability detecting step in a first frame satisfies a preset first determination condition,

the hardware processor (11A) holds position information of an image area detected by the search step in the first frame and controls the search step such that the detection processing is performed taking the held position information of the image area as an area to be detected in a subsequent second frame, when the first reliability is determined to satisfy the first determination condition,

the hardware processor (11A) determines whether a second reliability, detected by the reliability detecting step in the second frame, satisfies a second determination condition that is more relaxed than the first determination condition, when the second reliability is determined not to satisfy the first determination condition,

the hardware processor (11A) continues holding of the position information of the image area detected in the first frame and controls the search step such that the detection processing is performed taking the position information of the image area as an area to be detected in a subsequent third frame, when the second reliability is determined to satisfy the second determination condition, and

the hardware processor (11A) cancels holding of the position information of the image area and controls the search step such that processing of detecting an image area including the object to be detected is newly performed, when the second reliability is determined not to satisfy the second determination condition.

1. An image analysis apparatus comprising:
a processor configured with a program to perform operations comprising:
operation as a search unit configured to perform processing of detecting an image area comprising an object to be detected in units of frames from a temporally input image;
operation as a reliability detector configured to detect a reliability indicating likelihood of an image area comprising the object to be detected, detected by the search unit for each of the frames; and
operation as a search controller configured to control an operation of the search unit based on the reliability detected by the reliability detector,
wherein the processor is configured with the program such that operation as the search controller comprises operation as the search controller that performs operations comprising:
operation as a first determination unit configured to determine whether a first reliability detected by the reliability detector in a first frame satisfies a preset first determination condition;
operation as a first controller configured to hold position information of an image area detected by the search unit in the first frame, and configured to control the search unit such that the detection processing is performed taking the held position information of the image area as an area to be detected in a subsequent second frame, in response to the first reliability being determined to satisfy the first determination condition;
operation as a second determination unit configured to determine whether a second reliability, detected by the reliability detector in the second frame, satisfies a second determination condition that is more relaxed than the first determination condition in response to the second reliability being determined not to satisfy the first determination condition;
operation as a second controller configured to continue holding of the position information of the image area detected in the first frame, and configured to control the search unit such that the detection processing is performed taking the position information of the image area as an area to be detected in a subsequent third frame, in response to the second reliability being determined to satisfy the second determination condition; and
operation as a third controller configured to cancel holding of the position information of the image area, and configured to control the search unit such that processing of detecting an image area comprising the object to be detected is newly performed, in response to the second reliability being determined not to satisfy the second determination condition.

2. The image analysis apparatus according to claim 1, wherein the processor is configured with the program such that:
operation as the search unit comprises operation as the search unit that performs rough search processing of detecting an image area in which the object to be detected exists with first search accuracy and detailed search processing of detecting an image area in which the object to be detected exists with second search accuracy higher than the first search accuracy by taking, as an image area to be detected, the image area detected by the rough search processing and an area comprising a predetermined range around the image area based on position information of the image area;
operation as the reliability detector comprises operation as the reliability detector that detects a rough search reliability indicating likelihood of the image area comprising the object to be detected, detected by the rough search processing, and a detailed search reliability indicating likelihood of the image area comprising the object to be detected, detected by the detailed search processing,
operation as the first determination unit comprises operation as the first determination unit that determines whether the detailed search reliability satisfies a determination condition for detailed search; and
operation as the first controller comprises operation as the first controller that holds the position information of the image area detected by the search unit in the first frame in response to the detailed search reliability being determined to satisfy the determination condition for detailed search.

3. The image analysis apparatus according to claim 2, wherein the processor is configured with the program to perform operations such that:
operation as the second determination unit comprises operation as the second determination unit that, in response to the rough search reliability detected in the rough search processing for the second frame being determined not to satisfy a first determination condition for rough search, determines whether the rough search reliability detected in the rough search processing for the second frame satisfies a second determination condition that is more relaxed than the first determination condition;
operation as the second controller comprises operation as the second controller that, in response to the rough search reliability detected in the rough search processing for the second frame being determined to satisfy the second determination condition, continues holding of the position information of the image area; and
operation as the third controller comprises operation as the third controller that, in response to the rough search reliability detected in the rough search processing for the second frame being determined not to satisfy the second determination condition, cancels holding of the position information of the image area.

4. The image analysis apparatus according to claim 2, wherein the processor is configured with the program such that:
operation as the second determination unit comprises operations as the second determination unit that, in response to the detailed search reliability detected in the detailed search processing for the second frame being determined not to satisfy a third determination condition for detailed search, determines whether the rough search reliability detected in the rough search processing for the second frame satisfies a second determination condition that is more relaxed than the first determination condition for rough search;
operation as the second controller comprises operation as the second controller that, in response to the rough search reliability detected in the rough search processing for the second frame being determined to satisfy the second determination condition, continues holding of the position information of the image area; and
operation as the third controller comprises operations as the third controller that, in response to the rough search reliability detected in the rough search processing for the second frame being determined not to satisfy the second determination condition, cancels holding of the position information of the image area.

5. The image analysis apparatus according to claim 2, wherein the processor is configured with the program such that operation as the second determination unit comprises operation as the second determination unit that uses a reliability obtained by decreasing the rough search reliability detected by the reliability detector in the first frame by a predetermined value as the second determination condition.

6. The image analysis apparatus according to claim 3, wherein the processor is configured with the program such that operation as the second determination unit comprises operation as the second determination unit that uses a reliability obtained by decreasing the rough search reliability detected by the reliability detector in the first frame by a predetermined value as the second determination condition.

7. The image analysis apparatus according to claim 4, wherein the processor is configured with the program such that operation as the second determination unit comprises operation as the second determination unit that uses a reliability obtained by decreasing the rough search reliability detected by the reliability detector in the first frame by a predetermined value as the second determination condition.

8. An image analysis method executed by an image analysis apparatus comprising a hardware processor and a memory, the image analysis method comprising:
performing, by the image analysis apparatus, detection processing of detecting an image area comprising an object to be detected in units of frames from a temporally input image;
detecting, by the image analysis apparatus, a reliability that indicates likelihood of the detected image area comprising the object to be detected for each of the frames; and
controlling, by the image analysis apparatus, the detection processing based on the detected reliability,
wherein controlling the detection processing based on the detected reliability comprises:
determining whether a first reliability detected in a first frame satisfies a preset first determination condition;
holding position information of an image area detected in the first frame and controlling the detection processing such that the detection processing is performed taking the held position information of the image area as an area to be detected in a subsequent second frame, in response to the first reliability being determined to satisfy the first determination condition;
determining whether a second reliability, detected in the second frame, satisfies a second determination condition that is more relaxed than the first determination condition, in response to the second reliability being determined not to satisfy the first determination condition;
continuing holding of the position information of the image area detected in the first frame and controlling the detection processing such that the detection processing is performed taking the position information of the image area as an area to be detected in a subsequent third frame, in response to the second reliability being determined to satisfy the second determination condition; and
cancelling holding of the position information of the image area and controlling the detection processing that the detection processing of detecting an image area comprising the object to be detected is newly performed, in response to the second reliability being determined not to satisfy the second determination condition.

9. A non-transitory computer-readable storage medium storing a program, which when read and executed, causes a hardware processor included in the image analysis apparatus to perform operations comprising operations of the image analysis apparatus according to claim 1.

10. A non-transitory computer-readable storage medium storing a program, which when read and executed, causes a hardware processor included in the image analysis apparatus to perform operations comprising operations of the image analysis apparatus according to claim 2.

11. A non-transitory computer-readable storage medium storing a program, which when read and executed, causes a hardware processor included in the image analysis apparatus to perform operations comprising operations of the image analysis apparatus according to claim 3.

12. A non-transitory computer-readable storage medium storing a program, which when read and executed, causes a hardware processor included in the image analysis apparatus to perform operations comprising operations of the image analysis apparatus according to claim 4.

13. A non-transitory computer-readable storage medium storing a program, which when read and executed, causes a hardware processor included in the image analysis apparatus to perform operations comprising operations of the image analysis apparatus according to claim 5.

14. A non-transitory computer-readable storage medium storing a program, which when read and executed, causes a hardware processor included in the image analysis apparatus to perform operations comprising operations of the image analysis apparatus according to claim 6.

15. A non-transitory computer-readable storage medium storing a program, which when read and executed, causes a hardware processor included in the image analysis apparatus to perform operations comprising operations of the image analysis apparatus according to claim 7.
